(19) United States
(12) Patent Application Publication
(10) Pub. No.: US 2013/0220876 A1
(43) Pub. Date: Aug. 29, 2013

(54) DISPLAY CARTON WITH CONTROLLED DEFLECTION ZONES

(71) Applicant: Mars, Inc., (US)

(72) Inventors: William Wintermute, Hackettstown, NJ (US); Paul Freeman, Branchburg, NJ (US)

(73) Assignee: MARS, INC., McLean, VA (US)

(21) Appl. No.: 13/750,594

(22) Filed: Jan. 25, 2013

Related U.S. Application Data
(60) Provisional application No. 61/590,659, filed on Jan. 25, 2012.

(51) Int. Cl. B65D 25/00; B31B 1/00

(52) U.S. Cl. CPC B65D 25/00; B31B 1/00
USPC 206/736; 493/52

(57) ABSTRACT

A display carton with controlled deflection zones that are designed to control the weak points of the carton and to direct deformation of the carton when compressed. As more and more weight is added to the top surface of a carton that embodies a deflection zone, the deflection zone may initially resist crushing. As even more weight is added, the deflection zone may start to give way. The deflection zone helps to controlling the image of the container, even if the container becomes crushed. The display carton may incorporate different styles of deflection zones, and the display carton may incorporate the deflection zones at a variety of locations of the carton. Additionally, the controlled deflection zones can be incorporated into many different styles of display cartons, shipping containers, boxes and the like, including shipping containers that can be converted easily from a shipping configuration to a display configuration.

### FIELD OF THE INVENTION

One or more embodiments of the present invention relate to a display carton with controlled deflection zones. These controlled deflection zones can be incorporated into many different styles of display cartons, shipping containers, boxes and the like, including shipping containers that can be converted easily from a shipping configuration to a display configuration.

### BACKGROUND

Flat sheets of corrugated paperboard, typically referred to as blanks, have been used for many years as the starting material to form containers. Corrugated paperboard generally refers to a multi-layer sheet material comprised of two sheets of liner bonded to a central corrugated layer of medium. Given a basic size requirement specified by the customer, industry standards, and the preference for low cost, paperboard container manufacturers strive to provide structural stacking strength with a minimal amount of corrugated paperboard.

In shipping and displaying products, particularly in a retail setting, it is desirable to have a container which is easy to pack, sturdy and fully enclosed for protection of contents during storage and shipping, and also suitable for display at a retail site. For example, it is beneficial to have a container which allows a customer at a retail site to easily reach into the container and remove products for purchase. Of course, the access opening through which a consumer can access the products must also be closed during shipment and storage to prevent spilling of the product out of the container. This has resulted in the development of a variety of containers which are configured to be convertible from a shipping configuration to a display configuration, which permits the converted container to be placed directly upon a shelf, or floor display, without having to remove the individual product items from the container. Typically, this is accomplished by providing the container with removable portions of the container that create apertures through which customers may then help themselves to the products within the converted container.

Such convertible containers represent a challenge in that they must be readily convertible into a form presentable to customers, while at the same time maintaining certain shipping performance characteristics, suitable for the shipment of non-self-supporting or even fragile products. Prior attempts at providing a displayable shipping container may suffer from a number of disadvantages. For example, prior displayable shipping containers often are either lacking in the necessary shipping performance characteristics or, in order to provide such performance, have structural elements that remain in position after converting to a display configuration that make access to the product inconvenient.

Other displayable shipping containers are labor intensive to manufacture, assemble, or convert. And still other containers require excessive materials or, in some cases, extraneous components (e.g., a tie or a wrap) to secure a lid on a body of the container. Once converted to a display configuration, many displayable shipping containers often also include rough, unfinished, jagged, and uneven surfaces in prominent locations that are somewhat unsightly and do not provide the appeal of a neat, clean and presentable display.

Because of the industry push to minimize the amount of corrugated paperboard used to form a container and because of the desire to display a shipping container that is free of excessive structural elements, prior displayable containers tend to be somewhat weak, and in certain situations they can deform when stacked.

Therefore, it would be desirable to have a container that addresses many, if not all, of these disadvantages.

### BRIEF DESCRIPTION OF THE DRAWINGS

FIG. 1 is a side angled view of a container that includes a controlled deflection zone according to one embodiment of the present disclosure.

FIG. 2 is a side angled view of a container that includes a controlled deflection zone according to one embodiment of the present disclosure.

FIG. 3 is a close-up angled view of a deflection zone according to one embodiment of the present disclosure.

FIG. 4 is a close-up angled view of at least one deflection zone according to at least one embodiment of the present disclosure.

FIG. 5 is a top plan view of a blank for forming a container that includes a controlled deflection zone according to one embodiment of the present disclosure.

FIG. 6 is a top plan view of a blank for forming a container that includes a controlled deflection zone according to one embodiment of the present disclosure.

FIG. 7 is a top plan view of a blank for forming a container that includes a controlled deflection zone according to one embodiment of the present disclosure.

FIG. 8 shows top plan views of blanks for forming a container that may include a controlled deflection zone according to one embodiment of the present disclosure.

FIG. 9 is a top angled view of the container formed from the blanks of FIG. 8 in a shipping configuration.

FIG. 10 shows top angled views of the container formed from the blanks of FIG. 8 as the container is being converted from a shipping configuration to a display configuration.

FIG. 11 shows top plan views of blanks for forming a container that may include a controlled deflection zone according to one embodiment of the present disclosure.

FIG. 12 shows top plan views of blanks for forming a container that may include a controlled deflection zone according to one embodiment of the present disclosure.

FIG. 13 shows top plan view of blanks for forming a container that may include a controlled deflection zone according to one embodiment of the present disclosure.

### DETAILED DESCRIPTION

The display carton with controlled deflection zones is a unique approach for addressing the situations where a carton or container, formed from paperboard for example, perhaps a carton formed with minimal amounts of paperboard, and/or a container that is free of excessive structural elements, may deform when stacked.

Throughout this disclosure the terms “carton,” “container” and “box” may be used interchangeably to mean a structure, generally having a box shape, in which consumer goods may be shipped and/or displayed to consumers in the stores. Throughout this disclosure the term “blank” means a flat sheet of some material, for example paperboard, that is ready to fold into and become a portion of the container, or the whole container.

In one example, the complete carton may be formed from a single blank. Alternatively, a carton may consist of two or more main pieces or blanks, such as a bottom enclosure and a top cover. Accordingly, a container may include a first blank and a second blank. The first blank may include a first plurality of panels and a first plurality of flaps integrally formed from a first sheet of material. The first plurality of panels may include a first side panel, a second side panel opposing the first side panel, a back panel, and a front panel of the container. The first plurality of flaps may define a bottom of the container and a first portion of a top of the container. The front panel may include a window portion. The second blank may include two or more panels and two or more top flaps integrally formed from a second sheet of material. The two or more panels may include a cover front panel and a first side panel. The two or more top panels may define a second portion of the top of the container. The cover front panel may be attached to the window panel.

The containers of the embodiments described herein are typically manufactured using corrugated paperboard, preferably with the corrugations running in a vertical direction for increased strength. As non-limiting examples, the containers may be manufactured from C-flute, EB-flute, E-flute or B-flute corrugated paperboard. It is to be understood that the principles of this invention could be applied to containers made of other materials, such as non-corrugated paperboards, cardboard, corrugated fiberboard, non-corrugated fiberboard, solid-fiber board, polymeric materials, and other foldable materials.

One method of packing a shipping container is to place the consumer product inside smaller boxes and then stack the smaller boxes inside the larger main carton. Alternatively, the product to be shipped may be sold to consumers in a box (like cereal) or the product may be sturdy (self-supporting) enough to avoid structural failure of the outer carton when exposed to pressure. While the inner cartons can provide some structural strength, there will still be interior void space giving rise to the opportunity for the outer carton to deform especially when stacked. In any of these shipping arrangements, the inner boxes or sturdy product can provide additional support to the outer, main container so that even though the outer container may not fail, it may crush, sag or deform resulting in an unacceptable appearance. This can be particularly important in retail environments where at least a portion of the outer container is used to showcase the inner cartons. Therefore, these arrangements will still benefit from the solutions explained in this disclosure. It should be understood, however, that the solutions provided in this disclosure can be applied to a variety of shipping arrangements.

Another method of packing a shipping container is to place non-sturdy consumer products loosely inside the main container, without any internal boxes or containers. For example, it may be desirable to ship cartons which contain loose bags of chips or candy. The solutions explained in this disclosure are relevant to this type of packing and shipment of loose non-self-supporting or even fragile products because in this arrangement, there are no internal boxes or sturdy items inside the main carton to add support to the outer, main carton. Without any internal support the main container may tend to crush or deform when other containers are stacked on top of it (a phenomena called “nesting”). Specifically, the top of the container may sag (lower downward), and the vertical sides of the container may bow outward. Also, if the containers are imperfectly stacked, that is if the edges of the containers are not aligned, the weight of a container higher in the stack may not displace at ideal locations on a lower container, and this may cause sagging. Sagging, crushing or deforming of a container may cause the fragile contents of the container to get crushed.

One option to prevent sagging, crushing and deformation is to reinforce the carton. For example, if the vertical walls of the carton are reinforced, making them more resilient to bending or bowing, then when a heavy item is stacked on the carton, the vertical walls are less likely to bow and the top cover portion of the container is less likely to sag down. However, as explained, because there is an industry push to minimize the amount of paperboard used to form a container and because of the desire to display a container that is free of excessive structural elements, this disclosure describes solutions that are ideal for display-friendly cartons that are perhaps weaker, or less reinforced. It should be understood, however, that the solutions described in this disclosure may be applied either in conjunction with methods of reinforcing a container, or as an alternative to reinforcing a container. It can be particularly advantageous to add reinforcements in embodiments where the container houses non-sturdy or fragile products.

The design of the display carton with controlled deflection zones can be better understood when one accepts the fact that some display-friendly, perhaps weaker cartons may sag and deform by their nature when other cartons or other items are stacked on top them, in other words, when the carton gets compressed. Therefore, instead of attempting to completely prevent sagging and deformation, one or more solutions of the present disclosure aim to direct or divert the deformation or displacement of the container. In other words, the solutions of the present disclosure aim to engineer or control the weak points of the container, instead of leaving the deformation points to chance. In this respect, the seller or retailer may be able to control or manage the look of the container even though the container may crush or deform to some extent.

One advantage of being able to control the crushing of a container is that the seller or retailer of the goods can predict which parts of the container may be deformed, and which will remain in a condition presentable to consumers. Because a seller or retailer can predict which parts of the container will remain presentable to consumers, the seller or retailer can select areas of the container upon which to place images such as text, graphics, advertisements, and the like. The seller or retailer can choose these areas to place images before the container is shipped and have a higher degree of confidence that these images will still appear presentable (not deformed) when the container arrives and is displayed in the store.

Another advantage of being able to control the crushing of the container is that the seller or retailer of the goods can have a higher degree of confidence that the overall appearance of the container will remain presentable when the container arrives at the store. The controlled deflection zones or “crush zones” of the carton may be designed in such a manner and placed at such strategic locations so that any crushing or deformation of the container occurs at locations of the container that are not visible, or are at least less visible, to consumers. In this respect, even a slightly crushed and deformed container may still looks nice and presentable in the store.

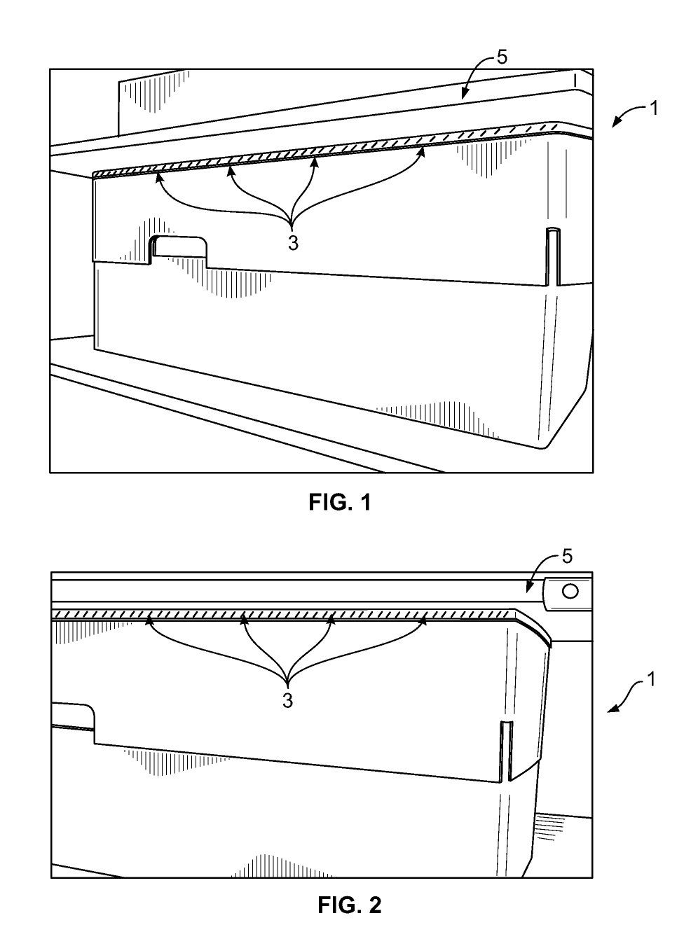

Turning now to FIG. 1, a side angled view of a container 1, in its “uncrushed” state, that includes a controlled deflection zone 3 according to one embodiment of the present disclosure. In this embodiment, the container 1 includes a deflection zone 3 (otherwise referred to as a “crush zone”) along at least one top edge of the container, where the side vertical wall of the container meets the top surface of the container. Preferably, each of the four top edges of the container will include a crush zone; however, it should be understood that one or more edges may not contain a crush zone.

Also depicted in FIG. 1 is an example of a heavy item 5 that may be stacked on top of the container 1, such that pressure may be applied downward to the top surface of the container 1. Note, however, that in FIG. 1, the container 1 is uncrushed because the full force of the heavy item 5 is not yet being realized. For the purposes of showing the container 1 in its uncrushed state, in FIG. 1, the full weight of heavy item 5 is either being restrained, or alternatively, there has not yet been any additional force applied downward to the heavy item 5, such that crushing of the deflection zone has not occurred yet.

FIG. 2 shows, more or less, the same side angled view of container 1, including a controlled deflection zone 3 according to one embodiment of the present disclosure, but contrary to FIG. 1, FIG. 2 shows the container 1 in a semi crushed state. In FIG. 2, the heavy item 5 is applying more pressure to the top surface of container 1, either because the full weight of heavy item 5 was released, or alternatively, because additional weight was applied downward to heavy item 5.

It should be understood that the heavy item 5 depicted in FIG. 1 is only an example of the many items that could be stacked on top of the container 1. For example, the heavy item 5 could be a flat slab as shown in FIG. 1, or alternatively, or in conjunction, one or more other containers of similar or different sizes may be stacked on top of the container 1.

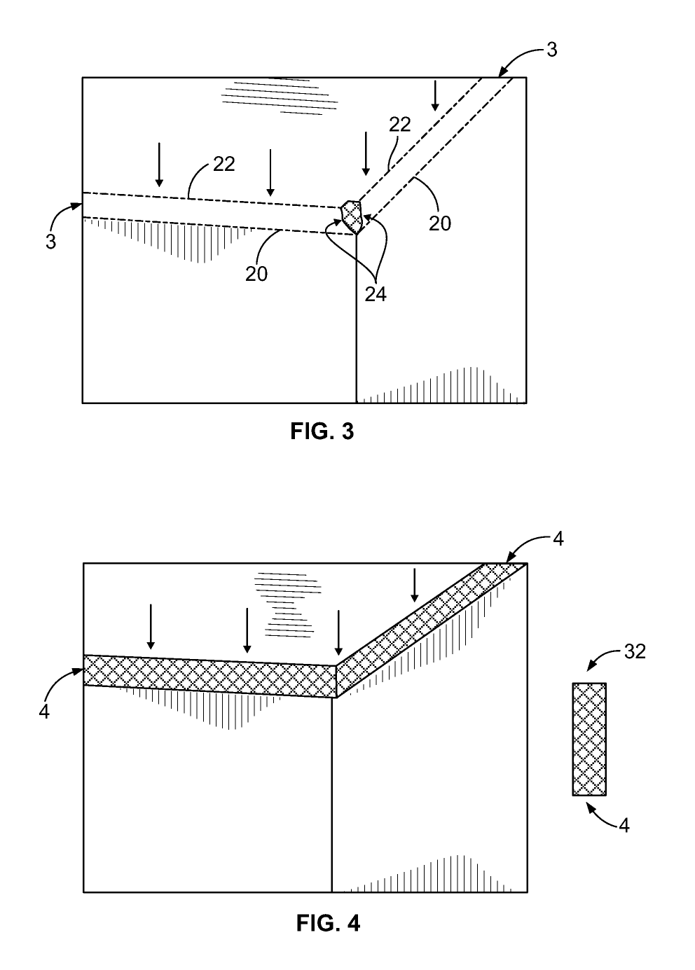

FIG. 3 shows a close-up angled view of a deflection zone 3 according to the embodiment of FIGS. 1 and 2. It should be understood that the style of deflection zone depicted in FIG. 3 is only one style of deflection zone contemplated by the present disclosure. This style of deflection zone 3 includes, for each edge of the container 1, a lower perforation line 20, an upper perforation line 22 and a contoured corner 24. The perforation lines 20, 22 may be formed in a variety of methods, for example, by making successive thin horizontal cuts or scores into the container. These cuts / scores may be, for example, stamped, rolled or imprinted into the container by a machine. The perforation lines may be imprinted onto the container in a variety of patterns as well (see FIG. 3). For example, either or both perforation lines could consist of successive lines, where all lines are the same length. Alternatively, the lines could alternate in a short-long-short-long pattern, or a short-short-long-short-short-long pattern, or similar patterns (like Morse code).

In some embodiments, the style of deflection zone may be formed by scoring the corrugated paperboard. Such scoring can be accomplished by scoring rollers using rubber rollers of varying hardnesses (as measured by durometer metrics). Using harder durometer rubber rollers can give score lines with deeper indentations from a higher degree of flattening. In addition to varying the hardness of the rollers, the width of the roller can be varied to create score lines of varying widths. Such rubber rollers can provide consistent score lines that allow more predictable and consistent deformation. As with the cuts, the score lines can be form a variety of patterns.

The deflection zone 3 may, alternatively, include more than two perforation or score lines, in any style of perforation or score pattern. As additional perforation or score lines are included in the deflection zone 3, the deflection zone 3 becomes more able to absorb weight from above or deflect compression forces. When the product stored in the container is more fragile or where the container is expected to withstand greater compressive forces, additional perforation or score lines can be included. In some embodiments with three or more perforation or score lines, the perforation or score lines may be evenly spaced, while in others they may be unevenly spaced.

Comparing the differences between FIG. 1 and FIG. 2, and analyzing the deflection zone design shown in FIG. 3, the functionality and benefit of the deflection zone 3 should be understood and appreciated. It can be seen that the deflection zone 3 in FIG. 2 appears vertically thinner than in FIG. 1. As more weight is added to the top surface of container 1, the deflection zone 3 may retain its upright structure initially because the surfaces of the container that cross the perforated lines 20, 22 may retain a degree of stiffness, even though the material of the container is cut, scored or perforated. As even more weight is added to the top surface of container 1, the surfaces of the container along the perforated lines may give way and start to bend or crease along the lines of perforation 20, 22. This bending / creasing can be seen in FIG. 2 where the surface of the container marked with dashed lines (the deflection zone 3) starts to angle toward the center of the container. Eventually, as even more weight is added to the top surface of the container 1, the heavy item 5, which is pressing downward on the container 1, may become flush with the lower edge of the deflection zone 3 (the lower perforation line 20).

FIG. 3 (and to some extent, FIG. 1) also depicts a contoured corner 24 of the container 1 and the deflection zone 3. In this embodiment, the contoured corner 24 allows two deflection zones 3 that may meet at a corner to crush or bend along their respected perforation lines without binding or restricting each other. Without the contoured corner 24, two deflection zones 3 may bind and restrict each other at the corner as they crush downward and inward. This may cause an unpredictable bulging, folding, rippling or ripping of the corner of the container 1. In line with one goal of this disclosure, it is desirable to control the image of the container, even if the container becomes crushed, and the contoured corner 24 helps to achieve this goal by leaving some room for the crush zones to move before they touch each other at the corners.

As mentioned, the style of crush zone depicted in FIGS. 1-3 is not the only style of crush zone contemplated by this disclosure. FIG. 4 shows two other styles of crush zones 4 that may be employed, including two cross-sections 30, 32 of these alternate styles of crush zone 4. One alternate style of crush zone may be a type of accordion-style layer 30. This accordion-style layer 30 may be manufactured in a variety of ways. For example, the surface of container 1 at the area of the deflection zone 4 may be folded in alternate directions along a series of perforation lines. Alternatively, the material of the container 1 at the area of the deflection zone 4 may be stamped or formed into an accordion-style layer during creation of the container 1.

Another alternate style of crush zone, also depicted in FIG. 4, may be a type of honeycomb-style layer 32. This honeycomb-style layer 32 may be manufactured in a variety of ways; however it is likely that the material of the container 1 at the area of the deflection zone 4 would be stamped or formed into a honeycomb-style layer during creation of the container 1.

Regarding either alternate style of crush zone 30, 32, the container 1 may also be manufactured by a method whereby the crush zones 30, 32 are stamped or formed separately from the rest of the container 1 and subsequently adhered to the appropriate location of container 1. This two-step manufacturing method may allow the parts of the container that are easier to stamp out (the main walls and flaps) to be manufactured separately from the parts of the container 1 that require a more complex manufacturing process (the alternate crush zones 30, 32).

As more and more weight is added to the top surface of a container 1 that embodies either alternate style of crush zone 30, 32, the crush zone may initially resist crushing because of the structural design of the crush zones 30, 32. As even more weight is added, the crush zone may start to give way and the internal structure of the crush zone may start to collapse, making the crush zone denser as either the accordion structure (30) or the honeycomb structure (32) begins to break down. These alternate styles of crush zones again help to achieve one goal of this disclosure—controlling the image of the container, even if the container becomes crushed. Even though the internal structure of the crush zone may collapse, the overall outer image of the container 1 remains presentable.

It should be understood that other styles of crush zones may be used according to this disclosure. For example, the crush zones could employ a variety of other cross-sectional structures. Additionally, the crush zone could be manufactured from a variety of materials, such as paperboard, cardboard, foam, rubber and the like.

Referring to FIG. 1 only for reference, the crush zone 3 may be utilized at other locations of the container 1 other than just at the top edges. For example, the crush zone 3 may instead be located at the bottom edges of the container 1, where the vertical side walls of the container 1 meet the bottom surface of container 1. Alternatively, container 1 may employ two crush zones, one along its top edges, and one along its bottom edges. In even further embodiments, crush zones may be added to the sides of a container such that the container is capable of absorbing compression forces or concussions experienced at the sides of the container.

In some embodiments, the crush zone may be designed to be easily removable. One benefit of an easily removable crush zone is that the container may be quickly prepared or converted for placement in a store, providing a shelf-ready container that retains an appealing, un-crushed appearance. Several methods may be employed to create a removable crush zone. For example, the container may include a perforated line below or at the base of the crush zone such that the crush zone may be cleanly torn or cut away and separated from the rest of the container. In another example, the container may include a rip cord or a ribbon that runs along the base of the crush zone such that a retailer, for example, may pull the ribbon to separate the crush zone from the rest of the container.

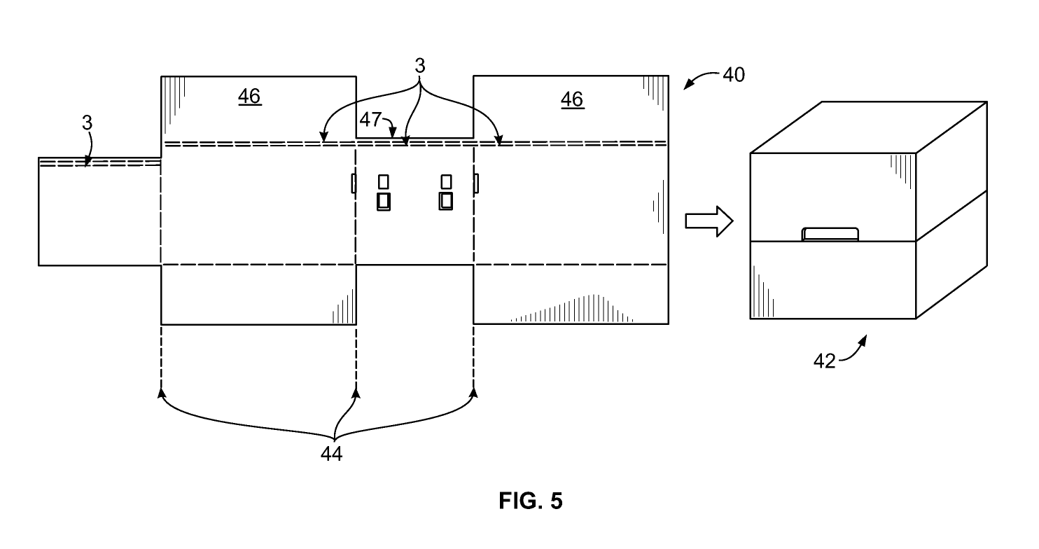

Any of the styles of crush zones, as explain herein, may be employed on a variety of styles of containers or boxes. FIG. 5 shows one style of container 42. Specifically, FIG. 5 shows a top plan view of a blank 40 for forming a container 42 that includes a controlled deflection zone 3 according to one embodiment of the present disclosure. When the container 42 is constructed from the blank 40, the blank 40 is creased and folded horizontally along lines 44. Then, the top flaps 46 and 47 are folded from their vertical orientation, creasing at the crush zone 3, and ending at a horizontal orientation. Top flaps 46 may overlap the shorter top flap 47, and top flaps 46 may be secured to flap 47, for example by tape, glue, clips, staples, pins or the like.

In some embodiments, care should be taken to construct the top surface of the container, including the folding of top flaps 46 and 47, such that the crush zone 3 is erected in an optimal orientation such that the crush zone 3 is prepared to deflect weight from above. For example, referring to the style of crush zone shown in FIGS. 1-3, care may be taken when folding the top flaps 46 and 47 such that the top line of perforation 22 is creased but the bottom line of perforation 20 is not creased, or minimally creased.

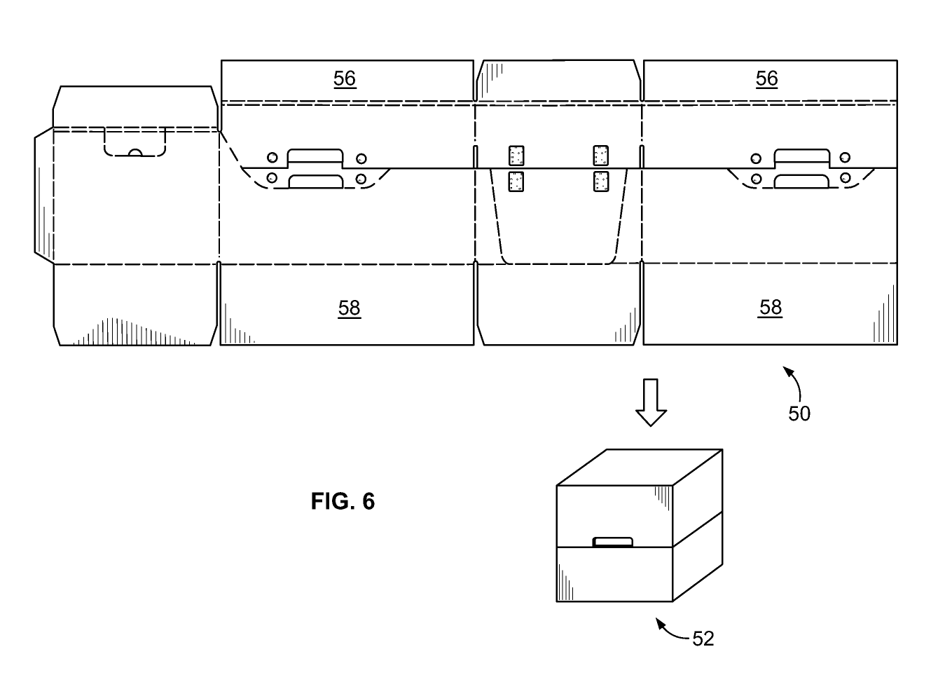

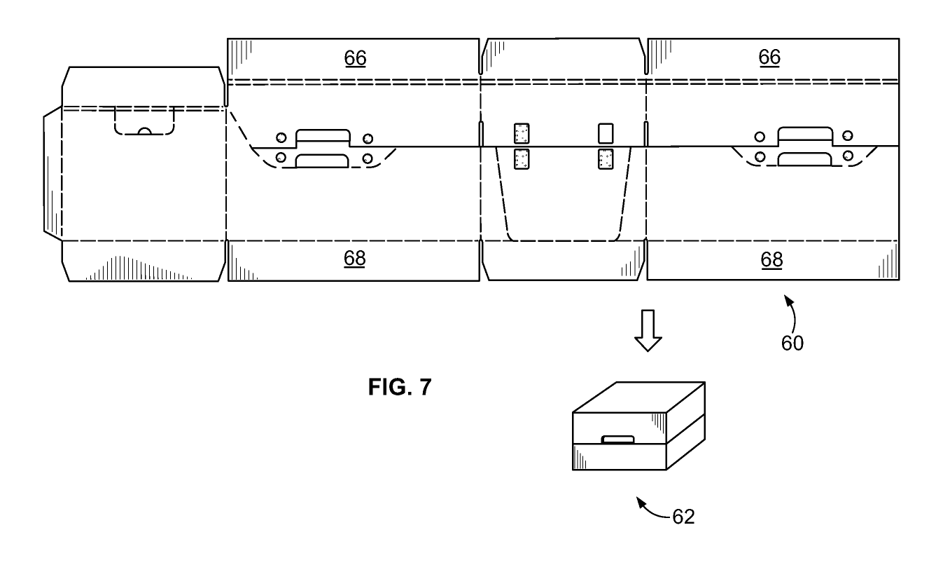

FIGS. 6 and 7 show two other styles of containers 52 and 62 formed from two other styles of blanks 50 and 60. These styles of containers are very similar to the styles of containers shown in FIG. 5, but the container 52 of FIG. 6 features a “shy'd” top flap, and the container 62 of FIG. 7 features “shy'd” top and bottom flaps. It should be understood that either one of these styles of containers 52, 62 may incorporate any of the styles of crush zones explained in this disclosure.

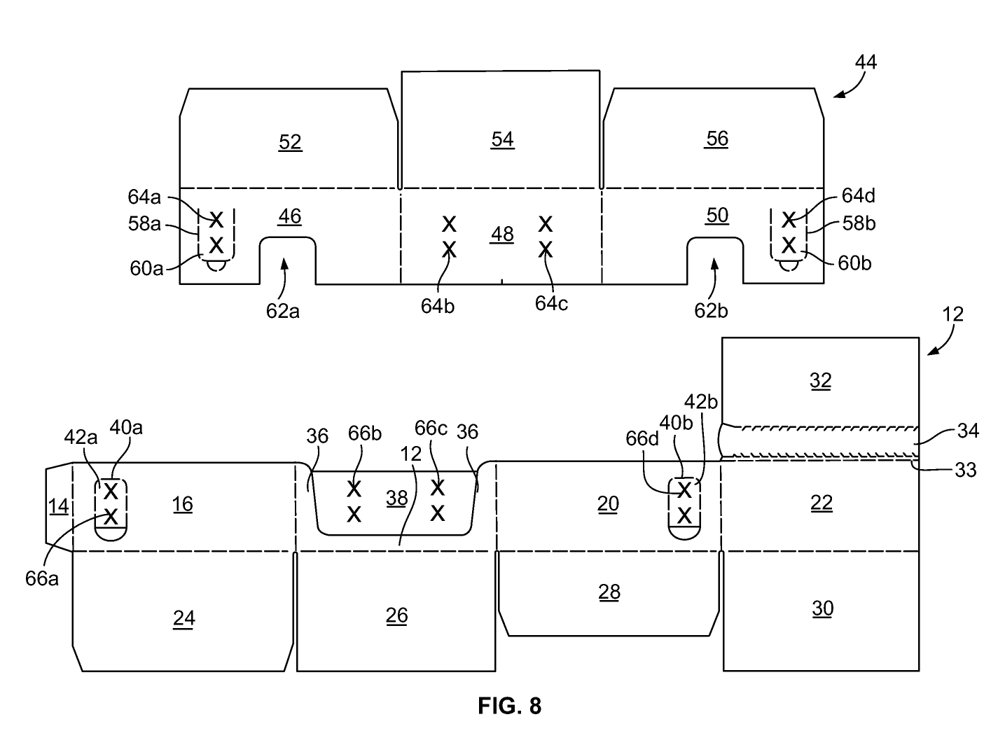

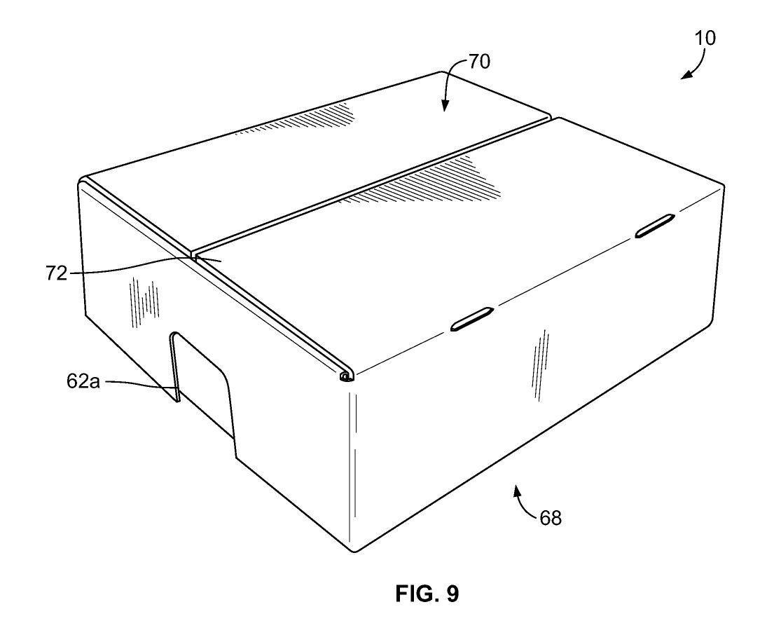

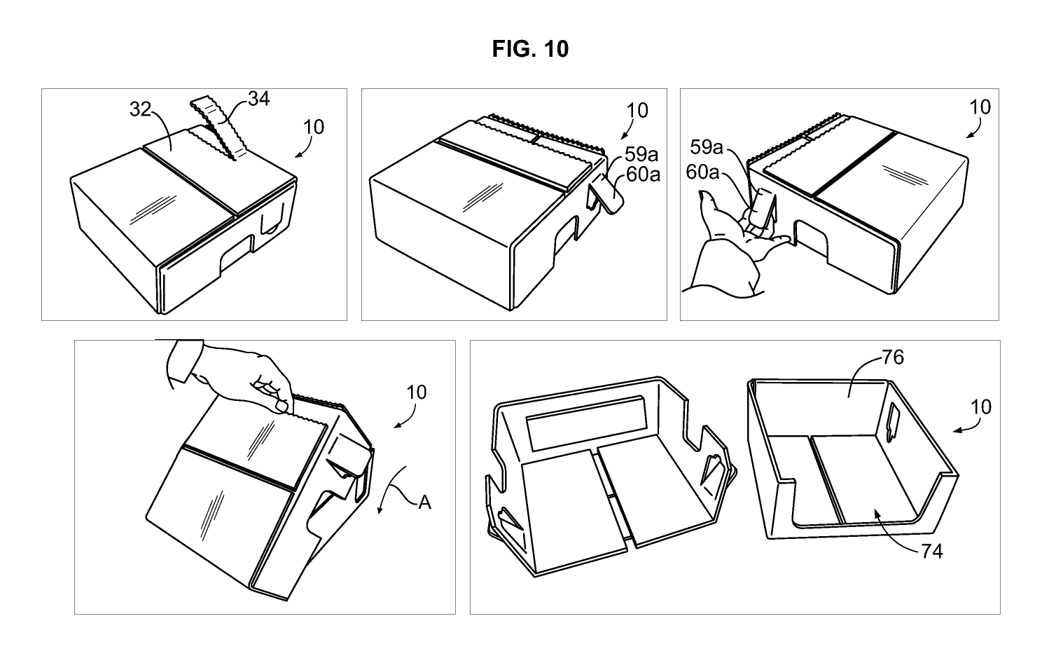

FIGS. 8-10 show another style of container, one that can be converted easily from a shipping configuration to a display configuration, and one that may incorporate any of the styles of crush zones explained in this disclosure. (For the purposes of this provisional application, the part numbers labeled in FIG. 8 should be ignored.) The container of FIGS. 8-10 is comprised of a top cover and a bottom enclosure. The bottom enclosure of the container includes a removable window portion. The container is assembled as follows: First, the top cover is attached to the bottom enclosure by applying an adhesive generally at or near one or more adhesive areas (denoted by X's) of the cover and/or one or more adhesive areas (denoted by X's) of the bottom enclosure. The blanks are then folded along dotted lines and the container is erected, packed with goods and sealed for shipping. In the shipping configuration, the cover is only attached to easily removable portions of the bottom enclosure, and thus, when the cover is removed to easily convert the container into its display configuration, the display provides a neat, clean, and presentable appearance. One benefit of using this style of container may be that the crush zone is incorporated into the cover that is removed before the product is displayed. Therefore, a consumer will not see any crushing effects that may be visible at the crush zone because the cover and crush zone have been removed and discarded.

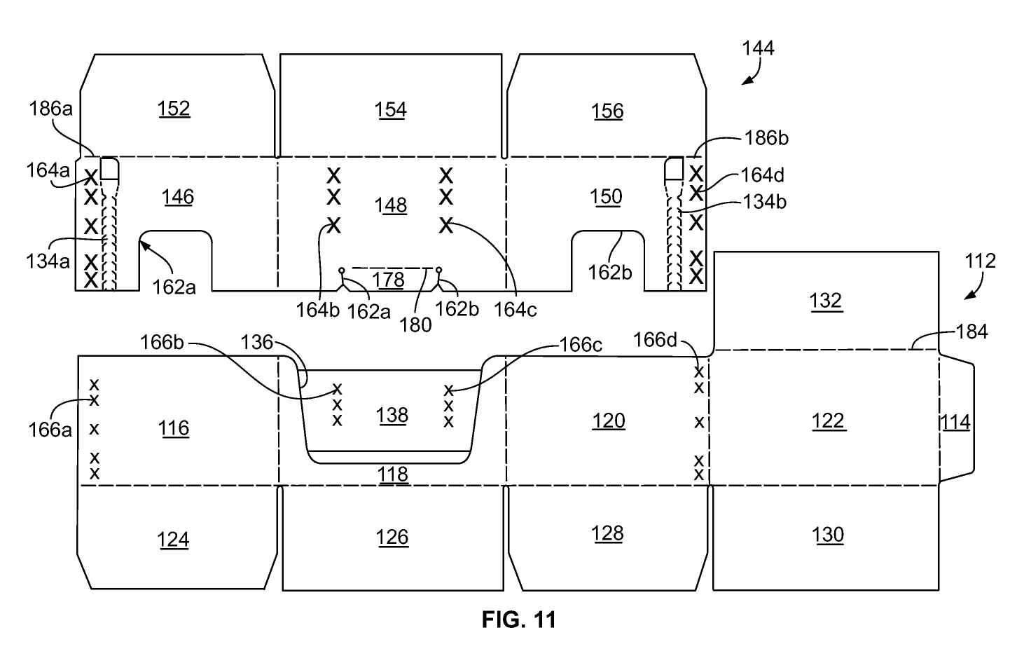

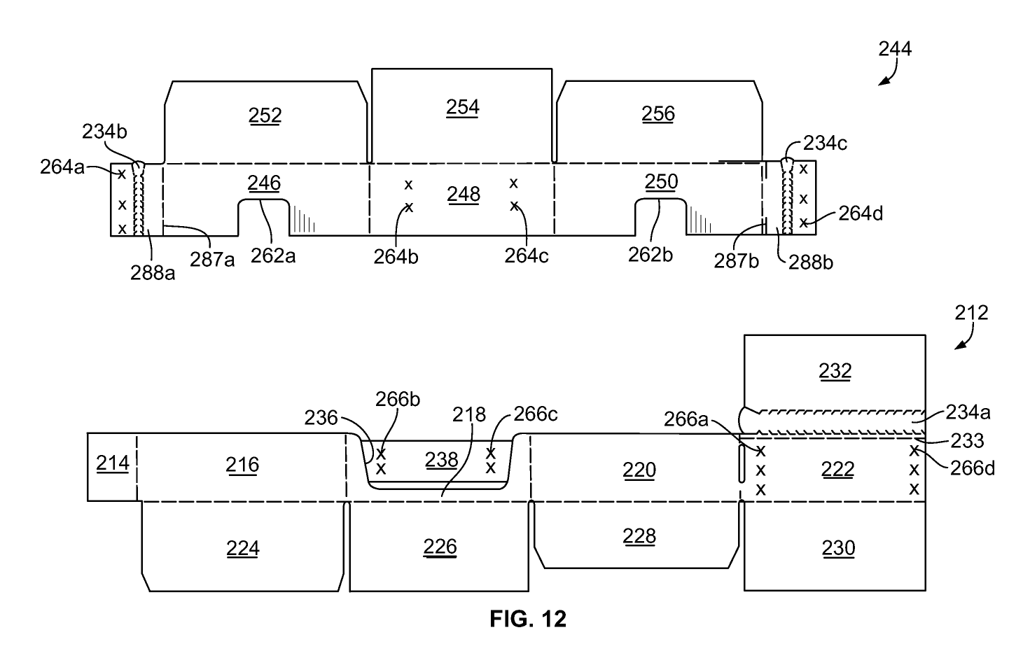

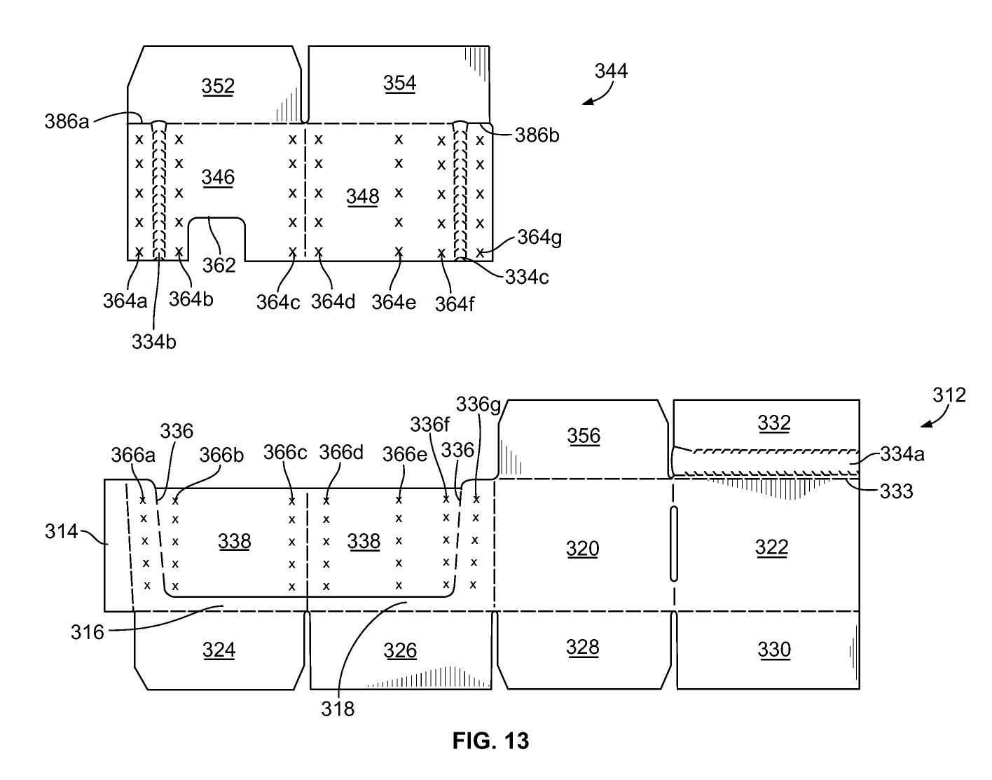

FIGS. 11-13 show three more styles of containers, containers that can be converted easily from a shipping configuration to a display configuration, and that may incorporate any of the styles of crush zones explained in this disclosure. (For the purposes of this provisional application, the part numbers labeled in FIG. 8 should be ignored.) The containers of FIGS. 11-13 are each comprised of a top cover and a bottom enclosure. The cover of each container includes at least one removable window portion. The containers are each assembled in a similar fashion to the containers of FIG. 8-10. First, the cover is attached to the bottom enclosure by applying an adhesive generally at or near one or more adhesive areas (denoted by X's) of the cover and/or one or more adhesive areas (denoted by X's) of the bottom enclosure. The difference between these styles of containers and the style of FIGS. 8-10 is that for the containers of FIGS. 11-13, in the shipping configuration, the cover may be attached to removable portions of the bottom enclosure, and/or removable portions of the cover may be attached to the bottom enclosure. Like the container of FIG. 8-10, these containers also result in a neat, clean, and presentable display when the cover is removed to easily convert the container into a display configuration. One benefit of using this style of container may be that the crush zone is incorporated into the cover that is removed before the product is displayed. Therefore, a consumer will not see any crushing effects that may be visible at the crush zone because the cover and crush zone have been removed and discarded.

Even further container styles, even those not shown or described in this disclosure, may incorporate any of the styles of crush zones explained in this disclosure. The container styles explained herein are some of the most cutting edge styles of containers, but any container with a relatively box-shaped top or cover could incorporate any of the styles of crush zones explained in this disclosure.

While the containers of the embodiments described above include glue or adhesive for attaching various panels and flaps of the containers, it is contemplated that any other suitable method of joining or attaching panels and flaps may be utilized such as, for example, staples, tapes, a system of corresponding slits and tabs, combinations thereof, and/or the like.

In an even further embodiment of the present disclosure, the problem of deformation of display-friendly containers during shipping may be addressed in an alternative manner, instead of or in conjunction with crush zones. In this embodiment, if the containers are shipped in a configuration such that most containers are packed adjacent to one or more other containers, the vertical walls of each container may be attached to the vertical walls of horizontally adjacent containers. For example, if the containers are packed and stacked in a cubed arrangement, this solution could be applied to each vertical layer of boxes, such that on each layer, the vertical walls of each box are attached to the vertical walls of each horizontally adjacent container.

One advantage of this solution is that the vertical walls of each container may gain side-by-side support or reinforcement from the walls of its adjacent containers. Thus, in effect, the thickness and sturdiness of the vertical walls of each container are doubled during shipping, which may help the container deflect weight from higher stacked containers and prevent crushing or deformation of the container. Another advantage of this solution is that when the containers reach their destination and are removed from the shipping configuration, each container resumes its original composition which meets the desires of the industry, specifically that the container is light-weight and free from unsightly structural elements.

In this embodiment, the walls of each container may be attached to the walls of horizontally adjacent containers with a variety of attachment means, for example, with a clamp, clip, pin, adhesive, magnet or other similar attachment means. It is preferable that the attachment means not leave any marks or residue on the wall of the containers when the containers are removed from their shipping configuration because containers free of marks or residue will be more presentable to consumers when on display in the store. Therefore, some attachment means may be more preferable than others, although, it should be understood that this embodiment includes attachment means of all kinds.

It should be understood that any of the solutions described in this disclosure may be used in conjunction with any of the other solutions described in this disclosure. For example, the solution whereby the vertical walls of a shipped container are attached to the walls of adjacent containers may be applied to containers that also have a controlled crush zone.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A shipping and display carton designed to control the weak points of the carton and to direct deformation of the carton when compressed, comprising:
a main carton structure, comprised of one or more blanks; and
one or more controlled deflection zones, wherein the controlled deflection zones crush in a controlled manner when the carton is compressed.

2. The shipping and display carton of claim 1, wherein the one or more controlled deflection zones are located along at least one top edge of the carton.

3. The shipping and display carton of claim 1, wherein the one or more controlled deflection zones are located along at least one bottom edge of the carton.

4. The shipping and display carton of claim 1,
wherein at least one controlled deflection zone is located along at least one top edge of the carton, and
wherein at least one controlled deflection zone is located along at least one bottom edge of the carton.

5. The shipping and display carton of claim 1, wherein the one or more controlled deflection zones comprise:
a lower perforation line; an upper perforation line; and a contoured corner.

6. The shipping and display carton of claim 1, wherein the one or more controlled deflection zones comprise:
a lower score line; an upper score line; and a contoured corner.

7. The shipping and display carton of claim 5, wherein the lower perforation line and the upper perforation line consist of successive thin horizontal cuts or scores into the carton.

8. The shipping and display carton of claim 1, wherein the one or more controlled deflection zones comprise more than one perforation line.

9. The shipping and display carton of claim 1, wherein the one or more controlled deflection zones comprise an accordion-style layer.

10. The shipping and display carton of claim 1, wherein the one or more controlled deflection zones comprise a honeycomb-style layer.

11. The shipping and display carton of claim 1, wherein the one or more controlled deflection zones are removable from the rest of the shipping and display carton.

12. The shipping and display carton of claim 1, wherein the main carton structure is comprised of a first blank and a second blank, and
wherein any part of the first blank that is adhered to the second blank is adhered to a removable portion of the second blank, and
wherein any part of the second blank that is adhered to the first blank is adhered to a removable portion of the first blank, and
wherein the main carton is convertible from a shipping configuration to a display configuration.

13. A method of making a shipping and display carton designed to control the weak points of the carton and to direct deformation of the carton when compressed, comprising:
providing a main carton structure, comprised of one or more blanks; and
creating one or more controlled deflection zones, wherein the controlled deflection zones crush in a controlled manner when the carton is compressed.
